(19) United States
(12) Patent Application Publication
(10) Pub. No.: US 2022/0014887 A1
(43) Pub. Date: Jan. 13, 2022

(54) METHODS PROVIDING SERVICE CONTEXT TRANSFER AND RELATED NETWORK NODES

(71) Applicant: Telefonaktiebolaget LM Ericsson (publ), Stockholm (SE)

(72) Inventors: Maria Cruz BARTOLOME RODRIGO, Madrid (ES); Attila MIHÁLY, Dunakeszi (HU)

(21) Appl. No.: 17/295,250

(22) PCT Filed: Nov. 19, 2019
(86) PCT No.: PCT/EP2019/081777

§ 371 Date: May 19, 2021

(30) Foreign Application Priority Data
Nov. 19, 2018 (EP) 18382826.8

(51) Int. Cl. H04W 4/50

(52) U.S. Cl. CPC H04W 4/50

(57) ABSTRACT

A controller node of a communication network may transmit a move context request to initiate a move of context information associated with a context identifier from a first storage resource node associated with a first service instance set for a service to a second storage resource node associated with a second service instance set for the service. Accordingly, a move context communication may be transmitted from a first service instance set associated with a first storage resource, wherein the move context communication includes context information from the first storage resource to be moved from the first storage resource node to a second storage resource node associated with a second service instance set.

The present disclosure relates generally to communications, and more particularly to communication networks and related methods and network nodes/entities/functions/servers.

5G System Rel-15 has been released as documented in 3GPP TS 23.501 v15.2.0 “System Architecture for 5G System” and 3GPP TS 23.502 v15.2.0 “Procedures for 5G System”.

The 5GC Control Plane as being defined in ongoing Rel-15 includes a disruptive change: traditional (pre-5GC) peer-to-peer interfaces and protocols are now replaced by a so-called SBA (Service Based Architecture), where each logical Network Function (NF) exposes one or multiple well-defined services (as a producer) to whatever other NF acting as service consumer by means of versioned HTTP2/REST APIs known as Service Based Interfaces (SBI). That is, there will be a network domain (basically the core network, CN) in which the different functional components are defined as Services, which are self-contained functionalities that can be changed and modified in an isolated manner (without affecting the other services).

A new Network Function named NRF (Network Repository Function) has been defined to provide NF-service discovery capabilities in 5GC, allowing NF-service producers to register their exposed NF-services (invoking the “NFRegister” operation offered through the “Nnrf_NFManagement” service by a NRF instance) for later NF-service consumers to discover them (through NRF exposed “Nnrf_NFDiscovery” service). A NF instance acting as service provider provides/updates at NF service registration time its “NF profile”, including (among other information) all provided NF services and, for each of them, the related end-point addresses.

The services in 5GC will likely be built in a stateless way, i.e., the business logic and data context will be separated. This means that the services store their context externally in a proprietary database DB. This will enable various cloud infrastructure features like auto-scaling or auto-healing.

In the context of the envisaged enhanced SBA (eSBA) as disclosed in 3GPP TR 23.742 v1.0.0 “Study on Enhancements to the Service-Based Architecture” (in the following denoted as “eSBA TR”) a concept of a set of instances is discussed, see therein Solution 11 in clause 6.11.

This solution proposes to define a Services Instance Set concept that can support high reliability and also has potential to improve other aspects of the 5GC architecture.

The key principles for Service Instance Sets are:
A Set of instances of the same service type.
All Service instances in a Set can access the same data storage e.g. UDSF.

As shown in FIG. 9, which corresponds to FIG. 6.11.2-1 of the eSBA TR, a Service Instance Set has a storage resource accessible by all service Instances in the Set. A Service Instance Set may expose individual service instances towards consumers or it can use a load balancer. If a load balancer is used the Service Instance Set may appear as one Service Instance towards consumers.

When a Service Instance Set exposes multiple service instances towards a consumer, the consumer is allowed to reselect a different Service Instance (within the same set) between transactions.

As shown in FIG. 10, which corresponds to FIG. 6.11.2-2 of the eSBA TR, a Service Instance Set may span multiple data centers.

As well, in the context of the eSBA TR, a requirement may be to achieve an independent management per each service, but sometimes this may not be possible as long as some defined services (in Rel-15) have some common data, that is accessed internally by implementation dependent interfaces. One possible solution for that problem is to do not consider those services as independent from a management perspective, but consider a group, referred to as a “deployment unit”. This deployment unit may include two or more instances of different service types that are deployed together and are single vendor. Since the Service instances within the deployment unit may share some data, it may be difficult to accommodate access to a same Storage Resource for different operations relating to a same context.

### SUMMARY

According one embodiment, a method is provided to operate a controller node of a communication network. A move context request is transmitted to initiate a move of context information associated with a context identifier from a first storage resource node associated with a first service instance set for a service to a second storage resource node associated with a second service instance set for the service.

There is further provided a method of operating a service instance set for a service of a communication network. A move context communication is transmitted from a first service instance set associated with a first storage resource, wherein the move context communication includes context information from the first storage resource to be moved from the first storage resource node to a second storage resource node associated with a second service instance set.

There is further provided a method of operating a service instance set for a service of a communication network. A store context request including context information is received, and the context information from the store context request is stored in a storage resource associated with the service instance set.

There are further provided a controller node and service instance sets adapted to perform the respective methods.

Operations regarding requests for the same service may thus be able to access the service that is provided by multiple service instance sets.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating service A instances deployed in two sets (also referred to as groups);

FIG. 2 is a message diagram illustrating selection of a same set for a same UE/session context;

FIG. 3 is a message diagram illustrating instance registration with a control service node according to some embodiments of inventive concepts;

FIG. 4 is a message diagram illustrating set selection for a UE/session context according to some embodiments of inventive concepts;

FIG. 5 is a message diagram illustrating set selection for a UE/session context for dependent services according to some embodiments of inventive concepts;

FIG. 6 is a message diagram illustrating a set 1 being unavailable in a service controller and context is transferred to Set 2 via the service controller according to some embodiments of inventive concepts;

FIG. 7 is a message diagram illustrating a set 1 being unavailable in a service controller and context is transferred to directly from Set 1 to Set 2 according to some embodiments of inventive concepts;

FIG. 8 is a message diagram illustrating an O& M triggered context transfer from Set 1 to Set 2 according to some embodiments of inventive concepts;

FIG. 9 is a block diagram illustrating a service instance set with a shared storage resource and an optional load balancer;

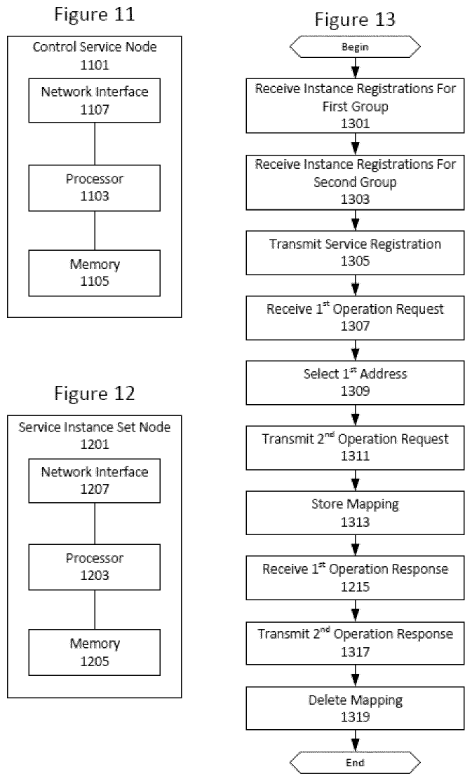

FIG. 10 is a block diagram illustrating a service instance set that spans across multiple data centers;

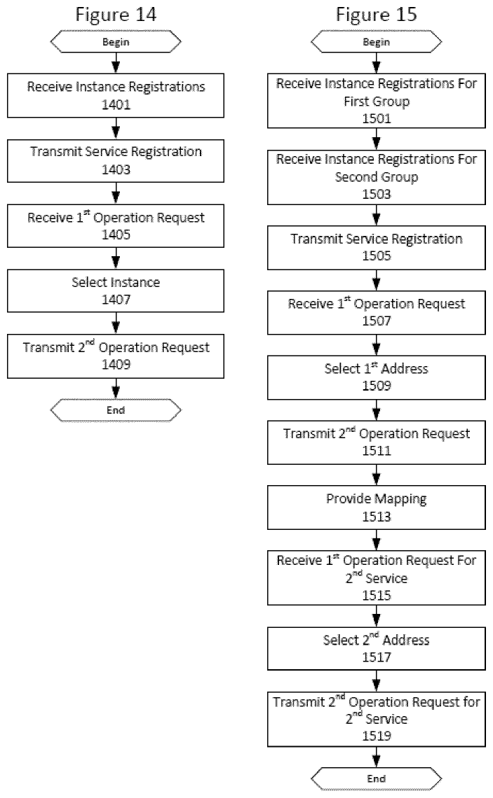

FIG. 11 is a block diagram illustrating a control service node according to some embodiments of inventive concepts;

FIG. 12 is a block diagram illustrating a service set instance node according to some embodiments of inventive concepts;

FIGS. 13-17 are flow charts illustrating operations of a control service node according to some embodiments of inventive concepts;

FIGS. 18-22 are flow charts illustrating operations of a service set instance node according to some embodiments of inventive concepts.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

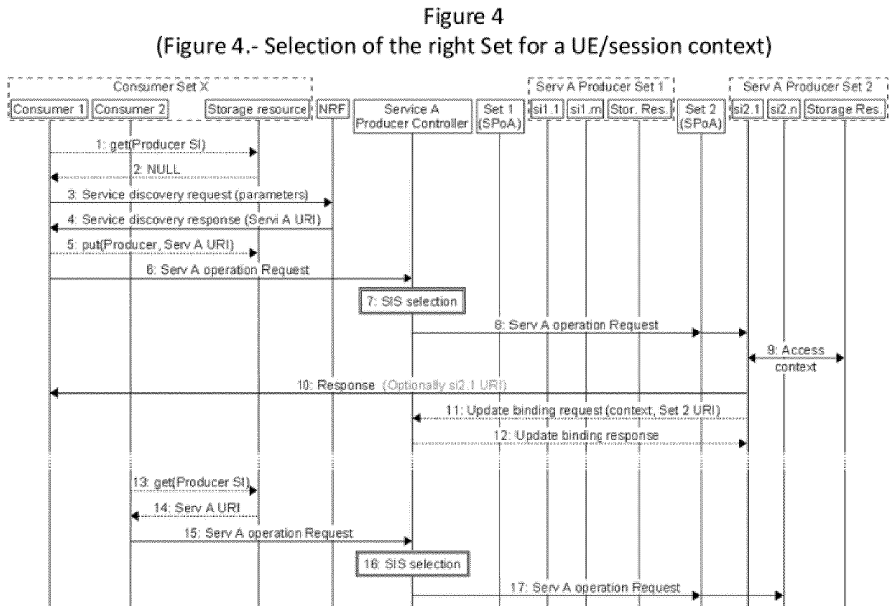

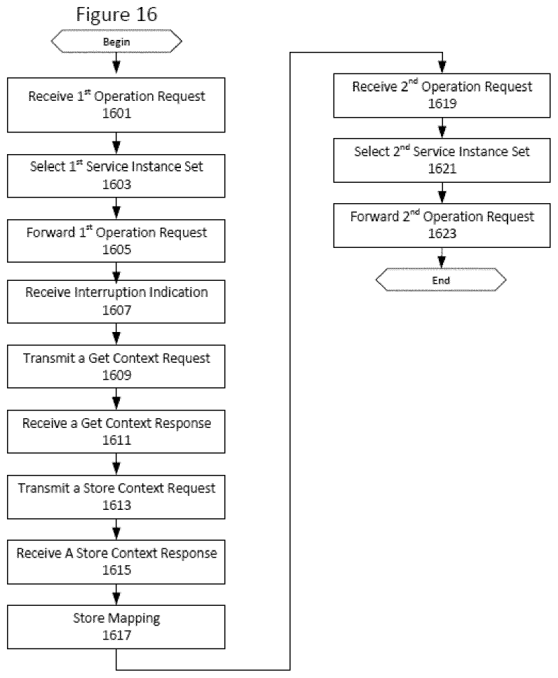

FIG. 11 is a block diagram illustrating elements of control service node/entity/function/server 1101 (also referred to as a control service node, a controller node, or a service controller node) configured to support cellular communication according to some embodiments of inventive concepts. As shown, control service node 1101 may include a network interface circuit 1107 (also referred to as a network interface) configured to provide communications with other network nodes/entities/functions/servers. The network entity may also include a processor circuit 1103 (also referred to as a processor) coupled to the network interface circuit 1107, and a memory circuit 1105 (also referred to as memory) coupled to the processor circuit. The memory circuit 1105 may include computer readable program code that when executed by the processor circuit 1103 causes the processor circuit to perform operations according to embodiments disclosed herein (e.g., operations illustrated in FIGS. 3, 4, 5, 6, 7, 8, 16 and/or 17, and/or operations discussed below with respect to respective example embodiments). According to other embodiments, processor circuit 1103 may be defined to include memory so that a separate memory circuit is not required.

As discussed herein, operations of the control service node 1101 may be performed by processor 1103 and/or network interface 1107. For example, processor 1103 may control network interface 1107 to transmit communications through network interface 1107 to one or more other network nodes/entities/functions/servers and/or to receive communications through network interface from one or more other network nodes/entities/servers. Moreover, modules may be stored in memory 1105, and these modules may provide instructions so that when instructions of a module are executed by processor 1103, processor 1103 performs respective operations. Operations of control service node 1101, for example, may be performed by one server or distributed across a plurality of network servers having the structure of FIG. 11, and a plurality of such distributed servers may be collectively referred to as a server. According to some embodiments control service node 1101 may be provided as a virtual control service node.

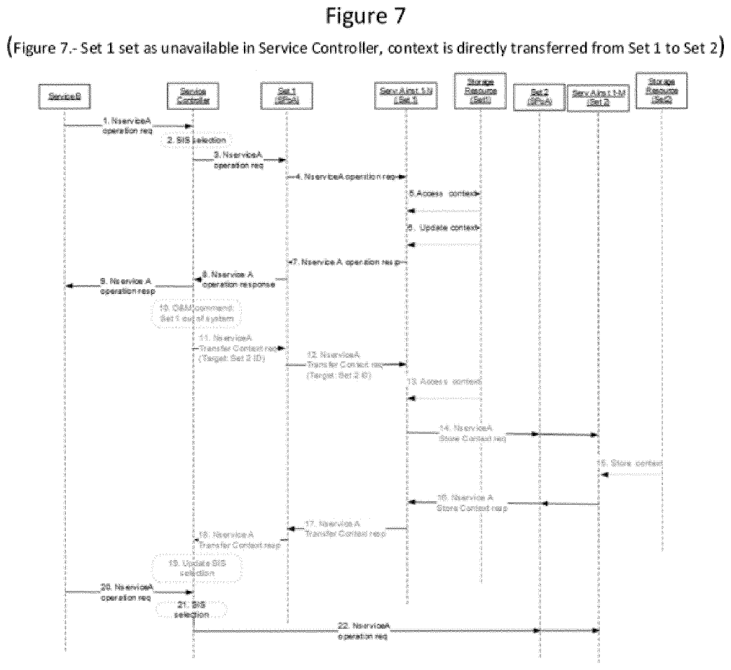

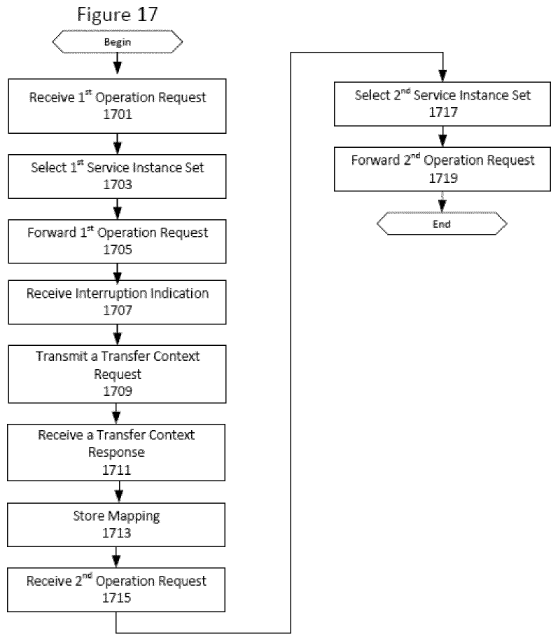

FIG. 12 is a block diagram illustrating elements of service instance set/node/entity/function/server 1201 configured to support cellular communication according to some embodiments of inventive concepts. As shown, service instance set 1201 may include a network interface circuit 1207 (also referred to as a network interface) configured to provide communications with other network nodes/entities/functions/servers. The network entity may also include a processor circuit 1203 (also referred to as a processor) coupled to the network interface circuit 1207, and a memory circuit 1205 (also referred to as memory) coupled to the processor circuit. The memory circuit 1205 may include computer readable program code that when executed by the processor circuit 1203 causes the processor circuit to perform operations according to embodiments disclosed herein (e.g., operations illustrated in FIGS. 6, 7, 8, 18, 19, 20, 21, and 22 and/or operations discussed below with respect to respective example embodiments). According to other embodiments, processor circuit 1203 may be defined to include memory so that a separate memory circuit is not required.

As discussed herein, operations of the service instance set 1201 may be performed by processor 1203 and/or network interface 1207. For example, processor 1203 may control network interface 1207 to transmit communications through network interface 1207 to one or more other network nodes/entities/functions/servers and/or to receive communications through network interface from one or more other network nodes/entities/servers. Moreover, modules may be stored in memory 1205, and these modules may provide instructions so that when instructions of a module are executed by processor 1203, processor 1203 performs respective operations. Operations of control service node 1201, for example, may be performed by one server or distributed across a plurality of network servers having the structure of FIG. 12, and a plurality of such distributed servers may be collectively referred to as a server. According to some embodiments service instance set 1201 may be provided as a virtual service instance set.

While FIGS. 11 and 12 illustrates the structure of a control service node/entity/function/server, and a service instance set/node/entity/function/server, respectively, other network nodes/entities/functions/servers may have the same/similar structure including a network interface, a processor, and memory. As used herein, a node may be a virtual node, a service, entity, function, and/or server. For example, such a structure including a network interface, a processor, and memory may be used for a consumer node/entity/functions/server, producer node/entity/functions/server, network repository function node/entity/functions/server, single point of access node/entity/functions/server, load balancer node/entity/functions/server, storage resource node/entity/functions/server, service instance node/entity/functions/server, NRF service instance node/entity/functions/server, etc. A radio access network RAN node may be provided using a similar structure with a transceiver also coupled with the processor to provide wireless communication with one or more wireless devices (also referred to as UEs, User Equipment, User Equipment nodes, wireless terminals, etc.) over a radio interface.

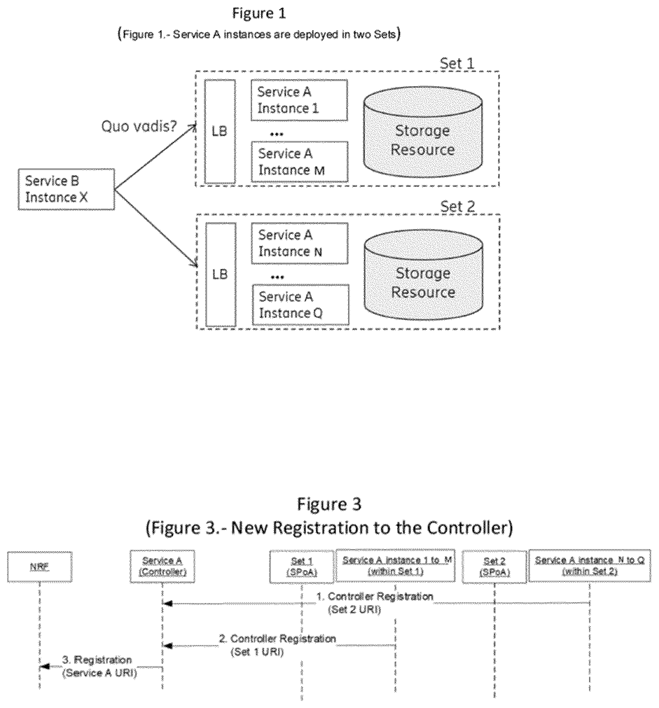

FIG. 1 is provided as an example, where instances of same Service A are deployed in two different Sets, i.e., there are two groups of instances (also referred to as sets of instances) that have access to different storage resources. FIG. 1 illustrates Service A deployed in two sets.

In FIG. 1, each set of instances may just offer one single point of access (e.g. a Uniform Resource Identifier, URI) to Service B (or any other consumer). As an example, a load balancer LB is included to reflect that, but other solutions may be possible, and this is not part of this disclosure.

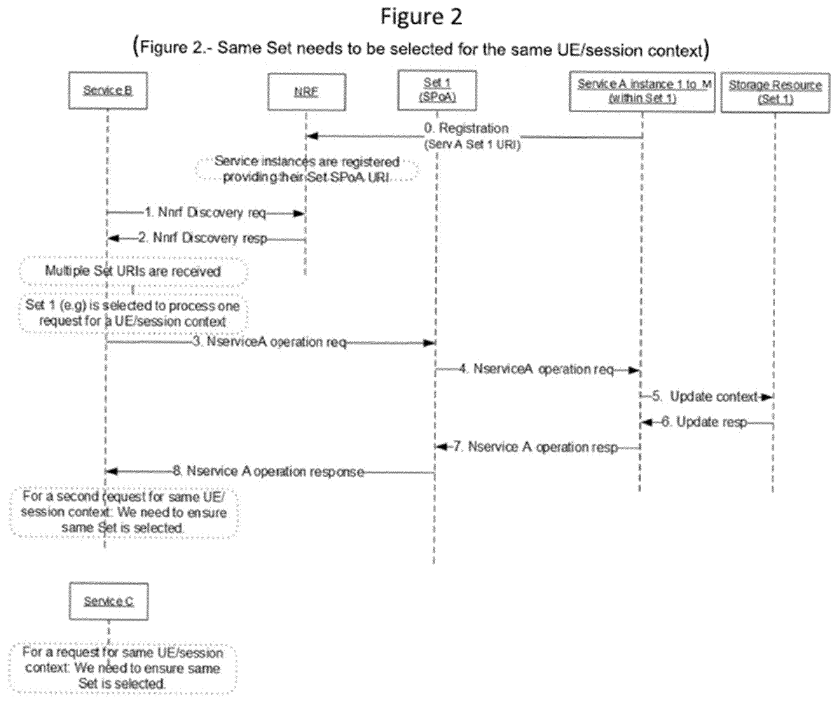

FIG. 2 illustrates a same set that may need to be selected for the same UE/session context. Operations of FIG. 2 are discussed below:

Operation 0. Service A instances registered to an NRF (also referred to as an NRF node/entity/function/server) providing a single URI for the whole Set. This may correspond to a LB or any other solution to hide the pool of instances. Set SPoAs (Single Point of Access) are displayed in the figure to ease understanding that the instances are not contacted directly by the end consumer, but via a SPoA for each Set.

Operation 1. Service B (valid a well for Service C, for any consumer of Service A) discovers Service A from the NRF.

Operation 2. Service B gets both Set 1 and Set 2 in the discovery response.

Operation 3. Service B selects one Set (either 1 or 2) to perform a Service A operation (e.g. a request) for a UE/session context (e.g. SUPI, PDU Session Id). Selection could be based in multiple criteria or even be random. In this example, Set 1 is selected, then Service B sends the Service A operation to the SPoA for Set1.

Operation 4. The operation will reach one instance within the Set. This may be done by means of a LB that selects the less loaded instance.

Operation 5. The execution of the Service A operation may modify the UE/session context, that is then stored in the Storage Resource that is deployed for Set1.

Operation 6. Response of the update operation

Operations 7 and 8. Response of the Service A operation

Then, a subsequent operation by Service B for the same UE/session context shall reach same Set. If a different Set is selected, this new operation may not take into account updated context by previous operation. This situation may be quite frequent, e.g. the AMF (also referred to as an AMF node/entity/functions/server) receives different interaction from the same UE (also referred to as a wireless device), for same or different DNN and NS SAI, then same or different PDU Sessions are created/selected . . . those values may identify a context that is modified and kept in the Storage Resource within the Set, that defines and state.

The same applies to any other Service (e.g. service C) that may be required to operate on the same UE/session context. This is as well quite frequent, e.g. for Exposure services, for Rel-15, each/most NFs have defined an Exposure service, that may be required to provide access to other NFs to the data that is managed by the NF (also referred to as an NF node/entity/functions/server), then the Exposure service should access data that is owned and manipulated by other NF services. Another example, some services allow an external service to subscribe to receive notifications upon certain events/updates, then the external service should send this subscription to the same Set (i.e. the exact same service (or group of services) that are able to access the same Storage Resource).

Apart from that, in the context of the eSBA TR (ref [3]) there may be a requirement to achieve an independent management per each service, but sometimes this may not be possible as long as some defined services (in Rel-15) have some common data, that is accessed internally by implementation dependent interfaces. But, even though in Rel-15 some services are defined with those dependencies, how to provide operation on that shared data (by multiple services, at least two) may be unresolved.

In summary, it may be desirable to provide operations on the same UE/session context by accessing the same Storage Resource.

Some embodiments herein may provide a new element named Service producer controller or control service node that acts as a Front-End of the multiplicity of service producer instances in the system/network/deployment. There may be only one single logical Service producer controller, but this does not preclude multiple instances being defined and hidden by e.g., a load-balancer or a DNS-based resolution service.

In the following disclosure, the term “Storage Resource Group” is used to refer to all the consumer instances that may be required to use the same Storage Resource, to be able to provide access to shared data, i.e. all consumer instances within a Set or within a Deployment Unit.

According to some embodiments disclosed herein, the Sets of instances may be registered to the new Controller (instead of to the NRF), while the Controller registers itself to the NRF with a single URI.

Then the Controller may keep track of registered Sets and their availability and may select the very same Set for the operations that may be required to access the same UE/session context, in order to provide that the operations always access the fresh updated data.

Procedures proposed in the present disclosure are described with the following call flows.

FIG. 3 illustrates a new registration to the controller.

A change is that only one SPoA, one URI is registered in the NRF as providing Service A, while each Set may need to register to the Controller rather than to the NRF. This is explained with respect to FIG. 3, where numbered operations do not need to go in any order, just numbered to ease description. Operations of FIG. 3 are discussed below:

Operation 1. Instances M to Q or service A are deployed in a Set (pool) offering as a single URI (e.g. of a LB). All the instances within the Set register a single URI is in the Controller entity as the SPoA for Set 2. This registration may be referred to as “Controller Registration” since it is not the existent registration in the NRF, however, the mechanism is similar.

In fact, the service instances do not need to know whether they register to the NRF or to a Controller, they could use exactly the same procedures and messages. In this sense this does not need to be standardized. This may allow inclusion in a deployment using a Controller by Ericsson, while the Service instances are by another vendor.

Operation 2. Similar to operation 1 for instances within Set 1.

Operation 3. Only one single URI is registered for Service A, this corresponds to the entity that acts as the controller for this Service A. Multiple instances of the controller could be instantiated, and then a single URI could be offered in the say way as for the Sets.

The controller registers into the NRF exactly as if it were a regular service A instance, then standardization may not be required.

Therefore, an Ericsson Controller could be included without any standardization need.

In the following call flow, there is a Service Instance Set (SIS) of the consumer service, and two different SISs for the service producer.

For the SIS consumer, the Storage Resource is included in the figure, that has been omitted for simplicity in SIS1_Producer and SIS2_Producer. Moreover, for the SIS Producers a SPoA is offered, by e.g. a LB, this is equally excluded from the figure.

In the figure, it is considered optional the existence of a separated Storage Resource as an independent and external service. This is why the interactions with this element are marked as optional (dotted lines).

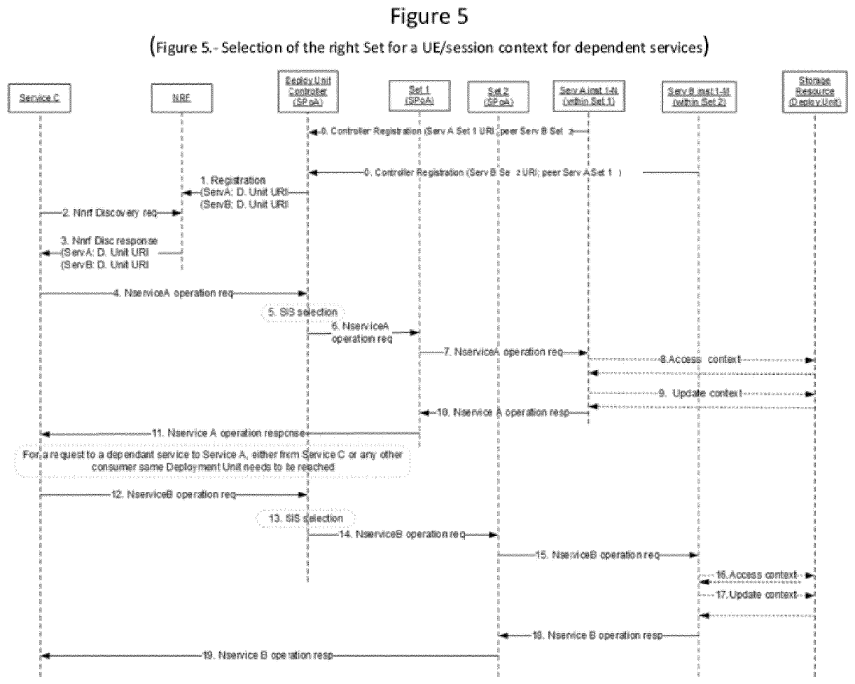

FIG. 4 illustrates Selection of the right Set for a UE/session context. Operations of FIG. 4 are discussed below:

Operation 1. Consumer 1 wants to send a request to Service A (producer), and then it first checks if the right address to use to contact that service is stored from a previous interaction.

Operation 2 In this example, the address is not stored.

Operation 3. Then the consumer needs to discovery the means to contact Service A.

Operation 4. Discovery response includes the Serv A URI. This corresponds to the “Serv A producer controller”, but from a consumer perspective the “Serv A producer controller” is just a Service A.

Operation 5. The consumer may store the Service A URI in the Storage Resource.

Operation 6. Consumer sends a Serv A operation request to the Service A, using the URI received that corresponds to the “Serv A Producer Controller”

Operation 7. The Controller receives the Service A operation request, and needs to select to which Set of instances it is sent. First, it must check if there is a Set already assigned to the corresponding UE/session context. The UE/session context shall be included in the Service A operation request, today it is considered an HTTP/REST interface, then it should be included in the HTTP body. E.g. if the operation is for SUPI-Y and for PDU Session Id-X, this should be included in the request. Then, the Controller reads the request and needs to know which parameters should be used to identify a UE/session context, e.g. SUPI and PDU Session. Then based on those, it checks if there is already a Set assigned, checking a mapping that has to be kept in permanent memory (either internal or external).

If a Set is already assigned to that UE/session context, then the same Set is selected. If there is not a Set assigned yet, then the Controller selects one from the available ones (in this case Set 1 and Set 2). The selection could be based on different criteria, e.g. load. Then, the controller keeps record of this assignment in permanent memory.

Operation 8. The controller forwards the Service A operation request to the selected Set (in this case Set 2 SPoA) using registered URI. The forwarded request includes the URI of the consumer. Set 2 SPoA chooses one instance within this Set, this selection could be based in different criteria (e.g. load). Corresponding Service A instance executes the request using the stored UE/session context in its Set Storage Resource.

Operation 9. The instance receiving the operation request accesses the stored context in order to be able to process the request. It may also need to manipulate part of the stored context.

Operation 10. The Service A operation response is sent back to the consumer (either directly, as in the figure, or through the Set 2 SPoA). It may optionally include the URI of the specific instance within the Set that has managed the request, that could be used to minimize extra hops and establish a direct communication during the same procedure execution flow.

Operations 11 and 12. In case this UE/session context is created or deleted, then the Controller has to either create or delete the corresponding mapping, in this case it is relevant that only when the operation has successfully performed the affected service instance informs back to the Controller.

Operation 13. In a later stage, another consumer instance within the same Consumer Set wants to send a request to Service A, then it first checks whether for that Service A contact URI is already available.

Operation 14. In this case, the Service A URI is available (it was stored in operation 5), then it is provided to the consumer instance 2.

Operation 15. Consumer instance 2 sends a Service A operation using stored URI, that corresponds to the Controller.

Operation 16. The Controller needs to select a Set. It needs to read corresponding parameters received in the request to be able to identify the UE/session context, and then check if it has already stored a mapping to any Set. In this case, this mapping has been stored in operation 11 (when it was created), then Set 2 (SPoA) is selected.

Operation 17. As in Operation 8, the Controller forwards the request to Set 2 SPoA, which chooses one instance within this Set, this selection could be based in different criteria (e.g. load).

As explained above, in the context of the eSBA TR (ref [3]) there may be a requirement to achieve an independent management per each service, but sometimes this may not be possible as long as some defined services (in Rel-15) have some common data, that is accessed internally by implementation dependent interfaces.

A possible solution for that problem is to not consider those services as independent from a management perspective, but fit those into a group. For example, if Service A and Service B have some data in common, (they are dependent to each other processing and updating of internal UE/session context), then they can be defined to be deployed always together as part of what may be referred to as a “Deployment Unit” DU.

This deployment unit may be provided in two or more instances of different service types, that then are deployed together and are single vendor. Since the Service instances within the deployment unit share some data, they need to access same Storage Resource, and this may be addressed according to some embodiments disclosed herein.

A similar solution to what is described above applies, with some modifications as explained in following call flow.

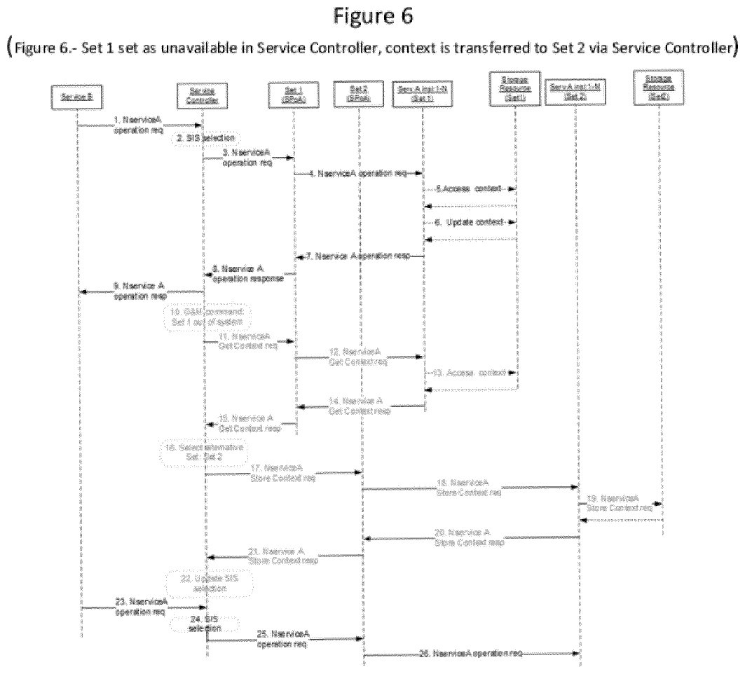

FIG. 5 illustrates selection of the right Set for a UE/session context for dependent services.

Operations of FIG. 5 are discussed below:

Operation 0. Similar to operation 1 in FIG. 3 above. The difference is that now the Controller acts as a controller for the whole Deployment Unit (DU), that involves two or more dependent services. Then, the controller keeps track of what services belong to the DU, and which Sets serve each service.

Another difference may be that in order to provide that both Service A and B have access to the same Storage Resource, a deployment requirement may be defined: same Storage Resource must be shared by at least one Set of the dependent services (A and B in our example). Then Service A Sets are peered with Service B Sets (peered Set access to the same Storage Resource). Information about Set peers is provided at Controller Registration, e.g., in a form of naming conventions in the set URIs.

Operation 1. DU Controller registers only its URI into the NRF, as the serving URI for all the services that belong to the DU. In this example, for Services A and B.

Operations 2 and 3. Service C wants to contact Service A, then it has to get its URI by NRF discovery. The DU URI is provided back for Service A. If Service C wants to use as well Service B (in operation 11), then same DU URI is provided.

Operation 4. Service C sends a Service A operation to the corresponding DU URI.

Operation 5. The DU controller needs to perform similar checks as in previous FIG. 4, operation 7, plus something else. In this case, the DU controller could receive requests for multiple services (A and B), that are identified by the same URI, while in the former case the URI of the Controller only identifies one single Service. Then, DU Controller needs to identify the right service name (in the request), to forward the request to the right Set.

Operations 6 to 11 are similar to FIG. 4, operations 8 to 10. FIG. 4 operations 11 and 12 may be applicable in this case as well, not included in the figure for simplicity.

Operation 12. Service C wants to execute a Service B operation, that is dependent to Service A. Then it sends the request to the URI received at discovery (operation 3), that corresponds to the same DU Controller.

Operation 13. The Controller performs same tasks as in FIG. 4, operation 16. The important difference is that in this case, the controller needs to select the Set for Service B (for the corresponding UE/session context) based on the assigned Set for dependent Services (in this case Service A). Only a peered Set could be selected, in order to have access to the same Storage Resource.

Operations from 14 to 19. They are similar to operations 6 to 11 in this flow.

Some embodiments of inventive concepts disclosed herein may provide one or more of the following advantages:
In the case of services (e.g. A and B) that have some dependencies (i.e., they share data), that are defined as a group (Deployment Unit), some embodiments may provide a solution to be able to access from the different services within the Deployment Unit to the same Storage Resource. This may allow that the Deployment Unit has independent LCM.
Some embodiments may provide that operations on the same UE/session context access the same Storage Resource, where this UE/session context is stored. Otherwise, any transaction that requires information about the current state may not work (and in 5GC most, if not all, transactions may be required to continue from a previous state).
Some embodiments may not impose any constraints on how the services are organized in sets and how the sets are scaled, and also may allow use of other methods to shorten the communication latency, e.g., based on direct communication between the service instances.

As discussed with respect to FIGS. 3-5, 11, 13, 14, and 15, herein, a control service node (also referred to as a service producer controller, controller node, and/or a service controller node) may act as a front end of a multiplicity of service producer instances (also referred to as service instance sets or service instance set nodes). There may only be one single logical Service producer controller, but this does not preclude multiple instances from being defined and hidden by e.g., a load-balancer or a DNS-based resolution service.

Instead of registering the Sets of instances to the NRF, the Sets of instances can be registered to the new Controller, which registers itself to the NRF with a single URI. Then the Controller keeps track of registered Sets and their availability, and selects the very same Set for the operations that require to access the same UE/session context, in order to ensure that the operations always access the fresh updated data.

Operators may require that even though the instances within a Set could be by a single vendor, there may be multiple Sets (for the same service type) by different vendors. One concern may be that a Set may become unavailable (e.g., failure, maintenance, . . . ) and operators may not want to be hooked to a single vendor.

This may require providing a way for a consumer to continue using a service when a new producer of Set1 (a first service instance set) takes over a former producer Set2 (a second service instance set). Potentially Set1 and Set2 are by different vendors.

Taking into account that each Set may own a Storage Resource as described with respect to FIG. 1 above, it may be desirable to provide a way to store required context in the new Service Storage Resource.

Some embodiments herein may provide a procedure to transfer a Service Context from a Set to an alternative Set.

This Service Context Transfer mechanism may be triggered by operation and maintenance (O&M) (e g manual intervention to take a Set out of the system).

This trigger may be received by the Service Controller Node, and three different methods are possible:
The Service Controller Node fetches the context from source Set and stores it in target Set.
The Service Controller Node requires source Set to store context directly in target Set.
The Service Controller Node requires target Set to fetch context from source Set.

As an alternative, the trigger could directly be received by either source or target Set, that can proceed with context transfer directly between then without the involvement of the Service Controller Node.

According to some embodiments, the following advantages may be provided:
Operators' requirements to deploy multiple Sets (for the same service type) by different vendors may be supported.
Context transfer may be provided to an alternative Set2 (for the same service type) in case Sell is set to unavailable by controlled means (e.g. planned SW upgrade). By this, a vendorX Service maybe upgraded while other vendorY keeps providing service.
The Service Controller Node, when taking control of the context transfer, may be able to select an alternative Set upon O&M command, based on configuration, or other criteria (e.g. Set load).

FIG. 6 illustrates a scenario where the Service Controller receives a trigger (e.g., an O&M command) to transfer Service Context data from Set 1 to Set 2.

FIG. 6.—Set 1 set as unavailable in Service Controller, context is transferred to Set 2 via Service Controller.

Operation 1. Service B (a consumer of service A) requests a Service A operation. For that it sends an operation to the Address received at Registration. (See discussion of FIGS. 4 and 5 for details about this part).

Operation 2. Service Controller selects the Set where the corresponding context is stored, using Context Id. In this example, Set 1 is selected. (See discussion of FIGS. 4 and 5 for details about this part).

Operation 3. Service Controller forwards the operation received to the Set 1. Any instance of Set 1 is potentially reachable, one instance in the Set may be selected based on different criteria (e.g. load). (See discussion of FIGS. 4 and 5 for details about this part).

Operation 4. One instance in Set 1 is attempted to be selected and the request is forwarded to this one.

Operation 5. Context data may be read from the Storage Resource of this Set, this is the unique place where this context is stored and up to date.

Operation 6. After the instance executes its business logic if the context is modified, it has to be updated in the Storage Resource.

Operation 7-9. Successful response

Operation 10. Controller receives an indication by e.g. O&M that Set 1 will be set out of service.

Operation 11. Controller has to fetch Service Context stored in Set 1 Storage Resource before the Set is allowed to be out of the system. For that, Controller executes a new operation Get Context. This operation has to be newly defined for all the services that are expected to support this mechanism, and this should be standardized to support multi-vendor Sets.

In this example Get Context is used as a generic operation to fetch whole Service Context, but it is equally possible to define just subgroups within the context to be transferred.

Operation 12. This operation is forwarded to one instance in the Set.

Operation 13. This instance executes the Get Context operation, that has to read Context from the Storage Resource.

Operation 14,15. Context is provided in the operation response to the Controller.

Operation 16. Controller selects an alternative Set2 to former Set1. This information is known at Registration (See discussion of FIGS. 3, 4 and 5 for details about this part).

Operation 17. Controller executes a new operation Store Context. This operation has to be newly defined for all the services that are expected to support this mechanism, and this should be standardized to support multi-vendor Sets.

Operation 18. This operation is forwarded to one instance within Set2.

Operation 19. Service instance executes the requested operation, updating the context in the Storage Resource of that Set2. With this, this Context is accessible for all the instances in Set 2.

Operation 20, 21. Successful execution of Context Storage response.

Operation 22. SIS selection is updated in Controller, indicating that this Context is stored now in Set2.

Operation 23. A new request is received for Service A for the same Context.

Operation 24. Controller selects corresponding Set, in this case, Set 2 is selected.

Operation 25. Request is forwarded to the right Set where the context is stored, after context transfer.

Alternatively, in this call flow, instead of the Operation 10, where the controller receives an indication to start the procedure to move the context, an O&M entity could take the role of the Controller.

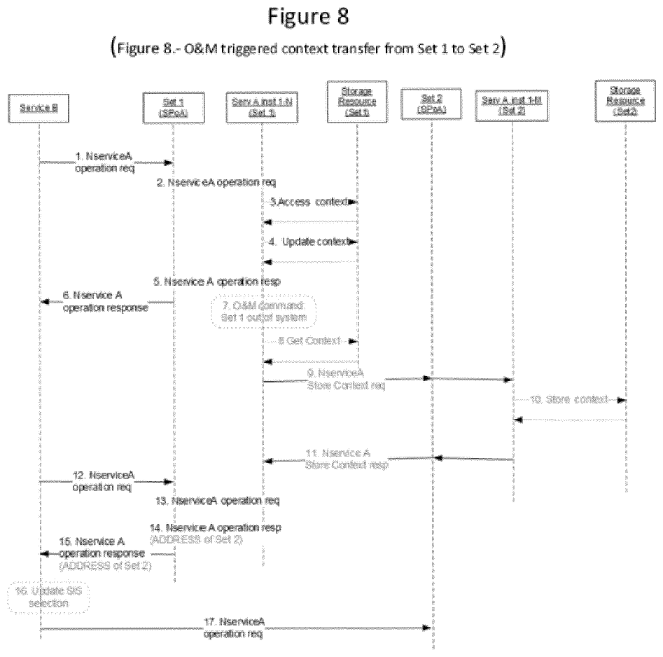

A variant of the above embodiment is shown in FIG. 7. Here, instead of fetching the context, the Service Controller instructs the Set 1 (e.g., one of its instances) in Operation 11 to transfer the context, indicating the target service instance (e.g., set) to where it should be transferred. Note that the opposite is also an option, i.e., contacting the target set (Set 2) and indicating the source set from where the context should be fetched. In FIG. 7, Set 1 (a first service instance set) may be set as unavailable in the service controller, and the context may be directly transferred from Set 1 to Set 2 (a second service instance set).

Note that in FIG. 7, the Service Controller uses a specific service operation in Operation 11 to instruct the source Set where to transfer the context. To support multivendor instances, this operation may require standardization.

In some embodiments, messages associated with operations 14 and 16 of FIG. 7 may go through an access node (e.g., a SPoA) that receives messages sent to Set 2 and from Set 2 and forwards the messages towards the message destination.

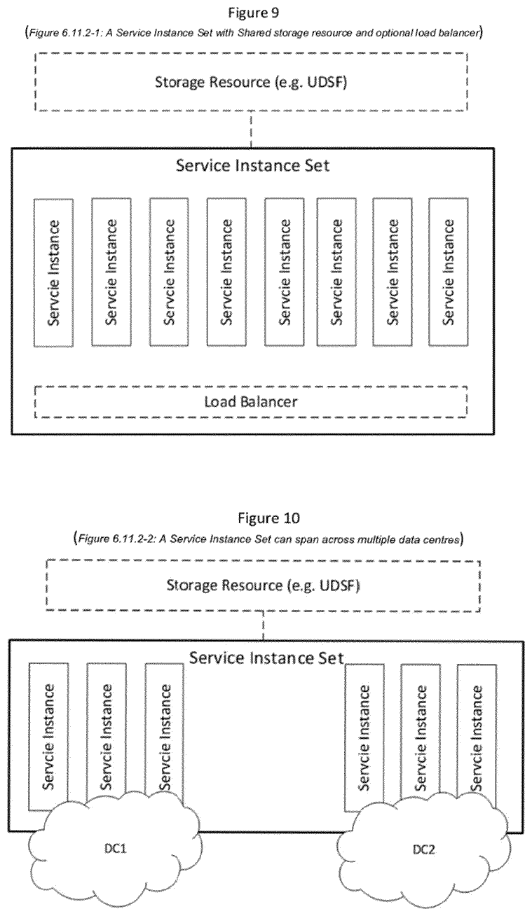

Alternatively, the Service Controller could just use the O&M interface of Set 1 to order the transfer. This may be directly done by the O&M system and then the Service Controller may not need to be involved. This embodiment is shown in FIG. 8. An advantage of the embodiment illustrated in FIG. 8 may be that the Controller knows the actual context mappings and it can also actualize these mappings instantly after the transfer has completed. In the O&M solution, there may be a way to actualize the context bindings in the potential Consumers, which is illustrated by Operation 12 in FIG. 8. In the example in FIG. 8 this may be triggered by the Set 1 instance response (Operation 14) after receiving the first request related to the given context after the context transfer (Operation 13). The response (that may be a redirect message) may include the means to reach of the new set (Set 2) e.g., in the form of FQDN.

In some embodiments, messages associated with operations 9 and 11 of FIG. 8 may go through an access node (e.g., a SPoA) that receives messages sent to Set 2 and from Set 2 and forwards the messages towards the message destination.

Both embodiments from FIG. 7 and FIG. 8 may reduce the volume of context transfer compared to FIG. 6 (context is transferred once instead of twice).

The separation of service logic and data, which may be an assumption for some embodiments described herein, may facilitate applying cloud-native design principles for services in the SBA domain.

In order to be able to support multi vendor service instances of the same service type, and be able to recover network service, some embodiments described herein may move context data in a standardized way. Service operations are described herein to achieve that.

Some embodiments may leverage on the Service Controller to control the transfer and update the mappings. If a Set is going to be removed from system or become unavailable for any other reason, then the Controller can be informed to proceed with context transfer from the actual Set to an alternative one.

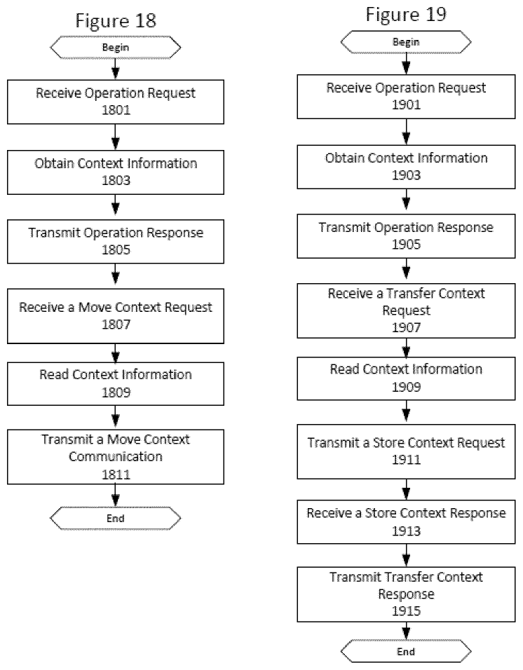

Operations of control service node/entity/function/server 1101 will now be discussed with reference to the flow chart of FIG. 13 according to some embodiments of inventive concepts. For example, modules may be stored in memory 1105 of FIG. 11, and these modules may provide instructions so that when the instructions of a module are executed by processor 1103, processor 1103 performs respective operations of the flow chart of FIG. 13.

At block 1301, processor 1103 may receive (through network interface 1107) instance registrations for respective instances of a first group of instances of a service provided within the communication network, and each of the instance registrations for the instances of the first group may include a same first address. Operations of block 1301 may be performed as discussed above with respect to operation 1 of FIG. 3.

At block 1303, processor 103 may receive (through network interface 1107) instance registrations for respective instances of a second group of instances of the service provided within the communication network, and each of the instance registrations for the instances of the second group may include a same second address, with the first and second addresses being different. Operations of block 1303 may be performed as discussed above with respect to operation 2 of FIG. 3.

At block 1305, processor 1103 may transmit (through network interface 1107) a service registration for the first and second groups of instances of the service to a registration node, with the service registration being transmitted based on receiving the instance registrations for the first and second groups of instances. The service registration may include a service address, with the service address being different than the first address, and with the service identifier being different than the second address. Operations of block 1305 may be performed as discussed above with respect to operation 3 of FIG. 3.

At block 1307, processor 1103 may receive (through network interface 1107) a first operation request for the service from a consumer node of the communication network, wherein the first operation request includes the service address and a context for a device, session, and/or subscription. Operations of block 1307 may be performed as discussed above with respect to operation 6 of FIG. 4.

At block 1309, processor 1103 may select the first address responsive to receiving the operation request for the service. Operations of block 1309 may be performed as discussed above with respect to operation 7 of FIG. 4.

At block 1311, processor may transmit a second operation request for the service from the control service node to an access (SPoA) node for the first group of instances of the service responsive to selecting the first address. The second operation request may include the first address and the context for the device, session, and/or subscription. Operations of block 1311 may be performed as discussed above with respect to operation 8 of FIG. 4. At block 1313, processor may store a mapping between the context and the first address, for example, based on the selecting of block 1309.

At block 1315, processor 1103 may receive (through network interface 1107) a first operation response from an instance of the first group of instances, with the first operation response corresponding to the second operation request, and with the first operation response relating to the context for the device, session, and/or subscription. Operations of block 1315 may be performed as discussed above with respect to operation 10 of FIG. 4.

At block 1317, processor 1103 may transmit (through network interface 1107) a second operation response to the consumer device, with the second operation response corresponding to the first operation response, and with the second operation response relating to the context for the device, session, and/or subscription. Operations of block 1317 may be performed as discussed above with respect to operation 10 of FIG. 4.

At block 1319, processor 1103 may delete the mapping between the context and the first address responsive to the first operation response of block 1315 including an indication of deletion of the context.

According to some other embodiments, operation responses may be transmitted directly from instances to consumer nodes bypassing the control service node, so that operations 1315, 1317, and 1319 may be omitted. In such embodiments, processor 1103 may receive (through network interface 1107) a request from an instance of the first group of instances, with the request including an indication of deletion of the context. Responsive to receiving such a request, processor 1103 may delete the mapping between the context and the first address. Such operations are discussed above with respect to operation 11 of FIG. 4.

Various operations from the flow chart of FIG. 13 may be optional with respect to some embodiments of control service nodes and related methods. Regarding methods of some embodiments, for example, operations of blocks 1307, 1309, 1311, 1313, 1315, 1317, and 1319 of FIG. 13 may be optional.

Operations of control service node/entity/function/server 1101 will now be discussed with reference to the flow chart of FIG. 14 according to some embodiments of inventive concepts. For example, modules may be stored in memory 1105 of FIG. 1, and these modules may provide instructions so that when the instructions of a module are executed by processor 1103, processor 1103 performs respective operations of the flow chart of FIG. 14.

At block 1401, processor 1103 may receive (through network interface 1107) instance registrations for respective instances of a service provided within the communication network. At block 1403, processor 1103 may transmit (through network interface 1107) a service registration for the instances of the service to a registration node, with the service registration being transmitted based on receiving the instance registrations, with the service registration including a service address, and with the service address being different than instance addresses of the respective instances. At block 1405, processor 1103 may receive (through network interface 1107) a first operation request for the service from a consumer node of the communication network, with the first operation request including the service address and a context for a device, session, and/or subscription. At block 1407, processor 1103 may select a respective one of the instances of the service responsive the operation request for the service. At block 1409, processor 1103 may transmit (through network interface 1107) a second operation request for the service from the control service node to the instance selected responsive to the operation request, with the second operation request including the context for the device, session, and/or subscription.

Various operations from the flow chart of FIG. 14 may be optional with respect to some embodiments of control service nodes and related methods.

Operations of control service node/entity/function/server 1101 will now be discussed with reference to the flow chart of FIG. 15 according to some embodiments of inventive concepts. For example, modules may be stored in memory 1105 of FIG. 11, and these modules may provide instructions so that when the instructions of a module are executed by processor 1103, processor 1103 performs respective operations of the flow chart of FIG. 15.

At block 1501, processor 1103 may receive (through network interface 1107) instance registrations for respective instances of a first group of instances of a first service provided within the communication network. Each of the instance registrations for the instances of the first group may include a first address. Operations of block 1501 may be performed as discussed above with respect to operation 0 of FIG. 5.

At block 1503, processor 1103 may receive (through network interface 1107) instance registrations for respective instances of a second group of instances of a second service provided within the communication network. Each of the registrations for the instances of the second group may include a second address, the first and second addresses may be different, and the first and second services may be different. Operations of block 1503 may be performed as discussed above with respect to operation 0 of FIG. 5.

At block 1505, processor 1103 may transmit a service registration for the first and second groups of instances, wherein the service registration is transmitted based on receiving the instance registrations for the first group of instances and the second group of instances. The service registration may include a service address, the service address may be different than the first address, and the service address may be different than the second address. Operations of block 1505 may be performed as discussed above with respect to operation 1 of FIG. 5.

At block 1507, processor 1103 may receive (through network interface 1107) a first operation request for the first service from a consumer node of the communication network. The first operation request may include the service address and a context for a device, session, and/or subscription. Operations of block 1507 may be performed as discussed above with respect to operation 4 of FIG. 5.

At block 1509, processor may select the first address responsive to receiving the first operation request for the first service. Operations of block 1509 may be performed as discussed above with respect to operation 5 of FIG. 5.

At block 1511, processor 1103 may transmit (through network interface 1107) a second operation request for the first service from the control service node to an access node for the first group of instances of the first service responsive to selecting the first address. The second operation request may include the first address and the context for the device, session, and/or subscription. Operations of block 1511 may be performed as discussed above with respect to operation 6 of FIG. 5.

At block 1513, processor 1103 may provide a mapping between the context and the first address and the between the context and the second address responsive to selecting the first address.

At block 1515, processor 1103 may receive (through network interface 1107) a first operation request for the second service. The first operation request for the second service may include the service address and the context for the device, session, and/or subscription. Operations of block 1515 may be performed as discussed above with respect to operation 12 of FIG. 5.

At block 1517, processor 1103 may select the second address responsive to receiving the first operation request for the second service. Processor 1103, for example, may select the second address based on the mapping of block 1113. Operations of block 1517 may be performed as discussed above with respect to operation 13 of FIG. 5.

At block 1519, processor 1103 may transmit (through network interface 1107) a second operation request for the second service from the control service node to an access (SPoA) node for the second group of instances of the second service responsive to selecting the second address. The second operation request may include the second address and the context for the device, session, and/or subscription. Operations of block 1519 may be performed as discussed above with respect to operation 14 of FIG. 5.

Various operations from the flow chart of FIG. 15 may be optional with respect to some embodiments of control service nodes and related methods. Regarding methods of some embodiments, for example, operations of blocks 1507, 1509, 1511, 1513, 1515, 1517, and 1519 of FIG. 14 may be optional.

According to some embodiments, the control service node may be collocated in a Unified Data Management UDM node and/or a UDR node so that embodiments herein may be performed in the UDM and/UDR node. In such embodiments as applied to FIG. 3, for example, the controller registrations of operations 1 and 2 may be replaced by a registration/update of information in the UDM and/or Unified Data Repository UDR.

According to some embodiments, a service instances may not need to register an SPoA for the respective set, but instead, the service instances may register each individual address in the control service node. The control service node may then select one of the instances within the set based on different criteria (e.g., load). In such embodiments, a separate SPoA may not be needed for the set, and it may be up to the control service node to perform selection of any instance within the set.

According to some embodiment, mapping may not be required. For example, the control service node may be able to uniquely identify a corresponding set based on parameters (e.g., context) received (e.g., by a hash).

Operations of control service node/entity/function/server 1101 (also referred to as a service controller node or a controller node) will now be discussed with reference to the flow chart of FIG. 16 according to some embodiments of inventive concepts. For example, modules may be stored in memory 1105 of FIG. 11, and these modules may provide instructions so that when the instructions of a module are executed by processor 1103, processor 1103 performs respective operations of the flow chart of FIG. 16.

At block 1601, processor 1103 may receive (through network interface 1107) a first operation request for a service. The first operation request may include a context identifier associated with context information for the service. The first operation request may be associated with a consumer node of the communication network. Operations of block 1601 may be performed as discussed above with respect to operation 1 of FIG. 6.

At block 1603, processor 1103 may select a first service instance set for the first operation request. The selection may be based on the first operation request including the context identifier. In some embodiments, the selection may be based on at least one of load, a pre-configuration, and/or a random selection. The first service instance set may include a first plurality of instances of the service. According to some embodiments, a mapping between the context identifier and the first service instance set may be stored before selecting the first service instance set, and the first service instance set may be selected based on the first operation request including the context identifier and based on the mapping between the context identifier and the first service instance set. Operations of block 1603 may be performed as discussed above with respect to operation 2 of FIG. 6.

At block 1605, processor 1103 may forward (through network interface 1107) the first operation request for the service to the first service instance set. The forwarding may be responsive to selecting the first service instance set for the first operation request. Forwarding the first operation request may in some embodiments include forwarding the first operation request to a first access node, such as a single point of access (SPoA) for the first service instance set. The context identifier may be forwarded with the first operation request. Operations of block 1605 may be performed as discussed above with respect to operation 3 of FIG. 6.

At block 1607, processor 1103 may receive an indication that service from the first service instance set will be interrupted. The indication may be received from an operation and maintenance node of the communication network. Operations of block 1607 may be performed as discussed above with respect to operation 10 of FIG. 6.

At block 1609, processor 1103 may transmit (through network interface 1207) a get context request to the first service instance set responsive to the indication that the service from the first service instance set will be interrupted. The get context request may initiate a move of context information associated with the context identifier from a first storage resource node associated with the first service instance set for the service to a second storage resource node associated with a second service instance set for the service. Operations of block 1609 may be performed as discussed above with respect to operation 11 of FIG. 6.

At block 1611, processor 1103 may receive a get context response from the first service instance set. The get context response corresponds to the get context request. The get context response may include the context information associated with the context identifier. Operations of block 1611 may be performed as discussed above with respect to operation 15 of FIG. 6.

At block 1613, processor 1103 may transmit a store context request to the second service instance set. The store context request may include the context information associated with the context identifier. Operations of block 1613 may be performed as discussed above with respect to operation 17 of FIG. 6.

At block 1615, processor 1103 may receive a store context response from the second service instance set after transmitting the store context request. The store context response corresponds to the store context request. Operations of block 1615 may be performed as discussed above with respect to operation 21 of FIG. 6.

At block 1617, processor 1103 may store a mapping between the context identifier and the second service instance after selecting the second service instance. Storing the mapping at block 1617 may occur after selecting the first service instance set at block 1603, responsive to receiving the indication at block 1607 that service from the first service instance set will be interrupted, and/or responsive to receiving the store context response of block 1611. Operations of block 1617 of mapping between the context identifier and the second service instance and be stored may be performed as discussed above with respect to operation 22 of FIG. 6

At block 1619, processor 1103 may receive a second operation request for the service after transmitting the get context request. The second operation request may include the context identifier. The second operation request may be associated with the consumer node of the communication network. Operations of block 1619 may be performed as discussed above with respect to operation 23 of FIG. 6.

At block 1621, processor 1103 may select the second service instance set for the second operation request. The selection may be based on the second operation request including the context identifier and based on the mapping between the context identifier and the second service instance set. The second service instance set may include a second plurality of instances of the service. Operations of block 1621 may be performed as discussed above with respect to operation 24 of FIG. 6.

At block 1623, processor 1103 may forward the second operation request for the service to the second service instance set responsive to selecting the second service instance set for the second operation request. Operations of block 1623 may be performed as discussed above with respect to operation 25 of FIG. 6.

In some embodiments, the communications to/from the first service instance set and/or the second service instance set may be through respective access nodes (e.g., Single Point of Access SPoA nodes). In these embodiments, the forwarding of the first operation request to the first service instance set may be forwarded to a first access node (SPoA) for the first service instance set, transmitting the get context request to the first service instance set may be transmitted to the first access node for the first service instance set, transmitting the transfer context request to the first service instance set may be transmitted to the first access node, receiving the get context response from the first service instance set may be received from the first access node for the first service instance set. Transmitting the store context request to the second service instance set may be transmitting the store context request to a second access node for the second service instance set, receiving the store context response may be received from the second access node for the second service instance set, receiving the transfer context request from the second service instance set may be received from the second access node and forwarding the second operation request to the second service instance set may be forwarding the second operation request to the second access node for the second service instance set.

Various operations from the flow chart of FIG. 16 may be optional with respect to some embodiments of control service nodes and related methods. Regarding methods of some embodiments, for example, operations of blocks 1601, 1603, 1605, 1607, 1611, 1613, 1615, 1617, 1619, 1621, and 1623 of FIG. 16 may be optional.

Operations of control service node/entity/function/server 1101 (also referred to as a service controller node or a controller node) will now be discussed with reference to the flow chart of FIG. 17 according to some embodiments of inventive concepts. For example, modules may be stored in memory 1105 of FIG. 11, and these modules may provide instructions so that when the instructions of a module are executed by processor 1103, processor 1103 performs respective operations of the flow chart of FIG. 17.

At block 1701, processor 1103 may receive (through network interface 1107) a first operation request for a service. The first operation request may include a context identifier associated with context information. The first operation request may be associated with a consumer node of the communication network. Operations of block 1701 may be performed as discussed above with respect to operation 1 of FIG. 7.

At block 1703, processor 1103 may select a first service instance set for the first operation request based on the first operation request including the context identifier. In some embodiments, the selection may be based on at least one of load, a pre-configuration, and/or a random selection. The first service instance set may include a first plurality of instances of the service. According to some embodiments, a mapping may be stored between the context identifier and the first service instance set, and the first service instance set may be selected based on the first operation request including the context identifier and based on the mapping between the context identifier and the first service instance set. Operations of block 1703 may be performed as discussed above with respect to operation 2 of FIG. 7.

At block 1705, processor 1103 may forward (through network interface 1107) the first operation request for the service to the first service instance set responsive to selecting the first service instance set for the first operation request. Forwarding the first operation request may in some embodiments include forwarding the first operation request to a first access node, such as a single point of access (SPoA) for the first service instance set. The context identifier may be forwarded with the first operation request. Operations of block 1705 may be performed as discussed above with respect to operation 3 of FIG. 7.

At block 1707, processor 1103 may receive (through network interface 1107) an indication to transfer the context information associated with a context identifier. The indication may be received from an operation and maintenance node of the communication network, and/or the indication may be an indication that service from the first service instance set will be interrupted. Operations of block 1707 may be performed as discussed above with respect to operation 10 of FIG. 7.

At block 1709, processor 1103 may transmit (through network interface 1207) a transfer context request to the first service instance set responsive to receiving the indication of block 1707. The transfer context request may initiate a move of context information associated with the context identifier from a first storage resource node associated with the first service instance set for the service to a second storage resource associated with a second service instance set for the service.

Operations of block 1709 may be performed as discussed above with respect to operation 11 of FIG. 7.

At block 1711, processor 1103 may receive a transfer context response from the first service instance set. The transfer context response corresponds to the transfer context request. Operations of block 1711 may be performed as discussed above with respect to operation 18 of FIG. 7.

At block 1713, processor 1103 may stores a mapping between the context identifier and the second service instance responsive to receiving the transfer context responseOperations of block 1713 of storing the mapping between the context identifier and the second service instance may be performed as discussed above with respect to operation 19 of FIG. 7.

At block 1715, processor 1103 may receive a second operation request for the service after transmitting the transfer context request. The second operation request may include the context identifier. The second operation request may be associated with the consumer node of the communication network. Operations of block 1715 may be performed as discussed above with respect to operation 20 of FIG. 7.

At block 1717, processor 1103 may select the second service instance set for the second operation request based on the second operation request including the context identifier. The second service instance set may include a second plurality of instances of the service. Moreover, the second service instance set may be selected based on the second operation request including the context identifier and based on the mapping between the context identifier and the second service instance set. Operations of block 1717 may be performed as discussed above with respect to operation 21 of FIG. 7.

At block 1719, processor 1103 may forward the second operation request for the service to the second service instance set responsive to selecting the second service instance set for the second operation request. Operations of block 1719 may be performed as discussed above with respect to operation 22 of FIG. 7.

In some embodiments, the communications to/from the first service instance set and/or the second service instance set may be through respective access nodes (e.g., SPoA nodes). In these embodiments, the forwarding of the first operation request to the first service instance set may be forwarded to a first access node (SPoA) for the first service instance set, transmitting the get context request to the first service instance set may be transmitted to the first access node for the first service instance set, transmitting the transfer context request to the first service instance set may be transmitted to the first access node, receiving the get context response from the first service instance set may be received from the first access node for the first service instance set. Transmitting the store context request to the second service instance set may be transmitting the store context request to a second access node for the second service instance set, receiving the store context response may be received from the second access node for the second service instance set, receiving the transfer context request from the second service instance set may be received from the second access node and forwarding the second operation request to the second service instance set may be forwarding the second operation request to the second access node for the second service instance set.

Various operations from the flow chart of FIG. 17 may be optional with respect to some embodiments of control service nodes and related methods. Regarding methods of some embodiments, for example, operations of blocks 1701, 1703, 1705, 1707, 1711, 1713, 1715, 1717, and 1719 of FIG. 17 may be optional.

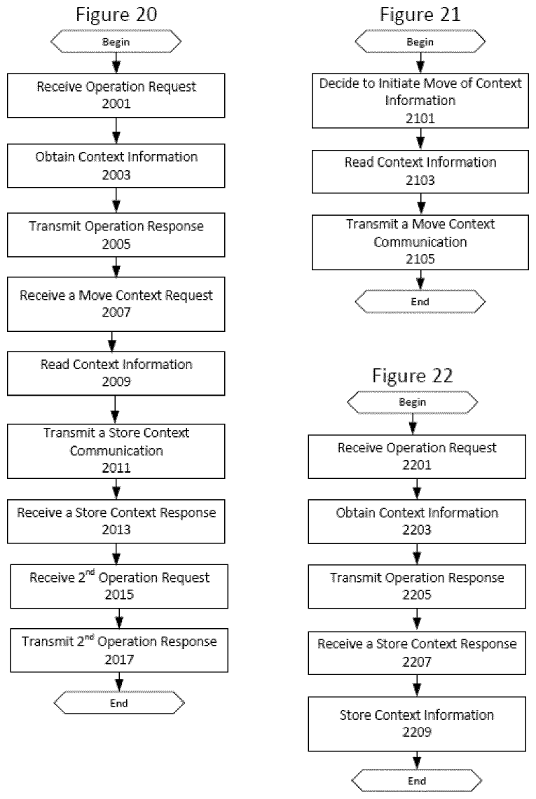

Operations of service instance set node/entity/function/server/1201 will now be discussed with reference to the flow chart of FIG. 18 according to some embodiments of inventive concepts. For example, modules may be stored in memory 1205 of FIG. 12, and these modules may provide instructions so that when the instructions of a module are executed by processor 1203, processor 1203 performs respective operations of the flow chart of FIG. 18.

At block 1801, processor 1203 may receive (through network interface 1207) an operation request for a service. The operation request may include a context identifier. The operation request may be associated with a consumer node of the communication network. Operation of block 1801 may be performed as discussed above with respect to operation 4 of FIG. 6.

At block 1803, processor 1203 may obtain (through network interface 1207) context information from the first storage resource responsive to the operation request including the context identifier. Operation of block 1803 may be performed as discussed above with respect to operation 5 of FIG. 6.

At block 1805, processor 1203 may transmit (through network interface 1207) an operation response associated with the consumer node responsive to receiving the operation request and based on the context information. Operation of block 1805 may be performed as discussed above with respect to operation 7 of FIG. 6.

At block 1807, processor 1203 may receive (through network interface 1207) a get context request to initiate a move of context information from a first storage resource node associated with the first service instance set to a second storage resource node associated with a second service instance set. According to some embodiments, the get context request may be received from the service controller node through an access node (e.g., SPoA node). Operations of block 1807 may be performed as discussed above with respect to operations 11 and/or 12 of FIG. 6.

At block 1809, processor 1203 may read the context information from the first storage resource associated with the first service instance set. In some embodiments, reading of the context information may include transmitting an access context request to the storage resource associated with the first service instance set responsive to receiving the move context request, and receiving an access context response from the storage resource associated with the first service instance set. The access context response may include the context information. Operation of block 1809 may be performed as discussed above with respect to operation 13 of FIG. 6.

At block 1811, processor 1203 may transmit (through network interface 1207) a get context communication from the first service instance set. The get context communication may correspond to the get context request, and the get context communication may include the context information. The get context communication including the context information may be transmitted based on reading the context information from the first storage resource. According to some embodiments, the get context communication may be transmitted from the first service instance set through an access node (e.g., an SPoA node) to the service controller node. Operation of block 1703 may be performed as discussed above with respect to operations 14 and/or 15 of FIG. 6.

Various operations from the flow chart of FIG. 18 may be optional with respect to some embodiments of control service nodes and related methods. Regarding methods of some embodiments, for example, operations of blocks 1801, 1803, 1805, and 1809 of FIG. 18 may be optional.

Operations of service instance set node/entity/function/server/1201 will now be discussed with reference to the flow chart of FIG. 19 according to some embodiments of inventive concepts. For example, modules may be stored in memory 1205 of FIG. 12, and these modules may provide instructions so that when the instructions of a module are executed by processor 1203, processor 1203 performs respective operations of the flow chart of FIG. 19.

At block 1901, processor 1203 may receive (through network interface 1207) an operation request for the service. The operation request may include a context identifier. The operation request may be associated with a consumer node of the communication network. Operation of block 1901 may be performed as discussed above with respect to operation 4 of FIG. 7.

At block 1903, processor 1203 may obtain (through network interface 1207) context information from the first storage resource responsive to the operation request including the context identifier. Operation of block 1903 may be performed as discussed above with respect to operation 5 of FIG. 7.

At block 1905, processor 1203 may transmit (through network interface 1207) an operation response associated with the consumer node responsive to receiving the operation request and based on the context information. Operation of block 1905 may be performed as discussed above with respect to operations 7 and/or 8 of FIG. 7.

At block 1907, processor 1203 may receive (through network interface 1207) a transfer context request to initiate a move of context information from a first storage resource node associated with the first service instance set to a second storage resource node associated with a second service instance set. Operations of block 1907 may be performed as discussed above with respect to operations 11 and/or 12 of FIG. 7.

At block 1909, processor 1203 may read the context information from the first storage resource associated with the first service instance set. In some embodiments, reading of the context information may include transmitting an access context request to the storage resource associated with the first service instance set responsive to receiving the move context request, and receiving an access context response from the storage resource associated with the first service instance set. The access context response may include the context information. Operation of block 1909 may be performed as discussed above with respect to operation 13 of FIG. 7.

At block 1911, processor 1203 may transmit (through network interface 1207) a store context request from the first service instance set to a second service instance set. The store context request may correspond to the transfer context request, and the store context request may include the context information. Operation of block 1911 may be performed as discussed above with respect to operation 14 of FIG. 7. At block 1913, processor 1203 may receive (through network interface 1207) a store context response from the second service instance set. Operation of block 1913 may be performed as discussed above with respect to operation 16 of FIG. 7.

At block 1915, processor 1203 may transmit (through network interface 1207) a transfer context response to the service controller node responsive to receiving the store context request. The transfer context response corresponds to the transfer context request. Operation of block 1915 may be performed as discussed above with respect to operation 17 of FIG. 7.

Various operations from the flow chart of FIG. 19 may be optional with respect to some embodiments of control service nodes and related methods. Regarding methods of some embodiments, for example, operations of blocks 1901, 1903, 1905, 1909, 1913, and/or 1915 of FIG. 19 may be optional.

Operations of service instance set node/entity/function/server/1201 will now be discussed with reference to the flow chart of FIG. 20 according to some embodiments of inventive concepts. For example, modules may be stored in memory 1205 of FIG. 12, and these modules may provide instructions so that when the instructions of a module are executed by processor 1203, processor 1203 performs respective operations of the flow chart of FIG. 20.

At block 2001, processor 1203 may receive (through network interface 1207) an operation request for a service. The operation request may include a context identifier. The operation request may be associated with a consumer node of the communication network. Operation of block 2001 may be performed as discussed above with respect to operation 2 of FIG. 8.

At block 2003, processor 1203 may obtain (through network interface 1207) context information from the first storage resource responsive to the operation request including the context identifier. Operation of block 2003 may be performed as discussed above with respect to operation 3 of FIG. 8.

At block 2005, processor 1203 may transmit (through network interface 1207) an operation response associated with the consumer node responsive to receiving the operation request and based on the context information. Operation of block 2005 may be performed as discussed above with respect to operation 5 of FIG. 8

At block 2007, processor 1203 may receive (through network interface 1207) a move context request to initiate a move of context information from a first storage resource node associated with the first service instance set to a second storage resource node associated with a second service instance set. In some embodiments, the move context request may be received from an operation and management node of the communication network. Operations of block 2007 may be performed as discussed above with respect to operation 7 of FIG. 8.

At block 2009, processor 1203 may read the context information from the first storage resource associated with the first service instance set. In some embodiments, reading of the context information may include transmitting an access context request to the storage resource associated with the first service instance set responsive to receiving the move context request, and receiving an access context response from the storage resource associated with the first service instance set. The access context response may include the context information. Operation of block 2009 may be performed as discussed above with respect to operation 8 of FIG. 8.

At block 2011, processor 1203 may transmit (through network interface 1207) a store context request from the first service instance set to the second service instance set. The store context request may correspond to the move context request. The store context request may include the context information. Operation of block 2011 may be performed as discussed above with respect to operation 9 of FIG. 8.

At block 2013, processor 1203 may receive (through network interface 1207) a store context response from the second service instance set. Operation of block 2013 may be performed as discussed above with respect to operation 11 of FIG. 8.

At block 2015, processor 1203 may receive (through network interface 1207) a second operation request. Operation of block 2015 may be performed as discussed above with respect to operation 13 of FIG. 8.

At block 2017, processor 1203 may transmit (through network interface) a second operation response responsive to receiving the second operation request. The response may include an address of a second service instance set. Operation of block 2017 may be performed as discussed above with respect to operation 14 of FIG. 8.

Various operations from the flow chart of FIG. 20 may be optional with respect to some embodiments of control service nodes and related methods. Regarding methods of some embodiments, for example, operations of blocks 2001, 2003, 2005, 2009, 2013, 2015, and/or 2017 of FIG. 20 may be optional.

Operations of service instance set node/entity/function/server/1201 will now be discussed with reference to the flow chart of FIG. 21 according to some embodiments of inventive concepts. For example, modules may be stored in memory 1205 of FIG. 12, and these modules may provide instructions so that when the instructions of a module are executed by processor 1203, processor 1203 performs respective operations of the flow chart of FIG. 21.

At block 2101, processor 1203 may decide to initiate a move of context information from a first storage resource node associated with a first service instance set to a second storage resource node associated with the second service instance. The deciding to initiate the move may be responsive to at least one of receiving a move context request, receiving a move context request from an operation and management node, receiving a get context request from a service controller node, receiving a transfer context request from a service controller node, and/or an internal event/trigger. Operation of block 2103 may be performed as discussed above with respect to operations 11 and/or 12 of FIG. 6, operation 11 of FIG. 7, and/or operation 7 of FIG. 8.

At block 2103, processor 1203 may read the context information from the first storage resource associated with the first service instance set. Reading of the context information may include transmitting an access context request to the storage resource associated with the first service instance set responsive to receiving the move context request, and receiving an access context response from the storage resource associated with the first service instance set. The access context response may include the context information. Operation of block 2103 may be performed as discussed above with respect to operation 13 of FIG. 6, operation 13 of FIG. 7, and/or operation 8 of FIG. 8.

At block 2105, processor 1203 may transmit (through network interface 1207) a move context communication from a first service instance set associated with a first storage resource. The move context communication may be transmitted responsive to deciding to initiate the move and based on reading the context information from the first storage resource. The move context communication may include the context information from the first storage resource to be moved from the first storage resource node to the second storage resource node associated with a second service instance set. Operation of block 2101 may be performed as discussed above with respect to operations 14 and 15 of FIG. 6, operation 15 of FIG. 7, and/or operation 9 of FIG. 8.

Various operations from the flow chart of FIG. 21 may be optional with respect to some embodiments of control service nodes and related methods. Regarding methods of some embodiments, for example, operations of blocks 2101 and/or 2103 of FIG. 21 may be optional.

Operations of service instance set node/entity/function/server/1201 will now be discussed with reference to the flow chart of FIG. 22 according to some embodiments of inventive concepts. For example, modules may be stored in memory 1205 of FIG. 12, and these modules may provide instructions so that when the instructions of a module are executed by processor 1203, processor 1203 performs respective operations of the flow chart of FIG. 22.

At block 2201, processor 1203 may receive (through network interface 1207) an operation request for a service. The operation request may include a context identifier. The operation request may be associated with a consumer node of the communication network. Operation of block 2201 may be performed as discussed above with respect to operation 4 of FIG. 6, operation 4 of FIG. 7, and/or operation 2 of FIG. 8.

At block 2203, processor 1203 may obtain (through network interface 1207) the context information from the first storage resource responsive to the operation request including the context identifier. Operation of block 2203 may be performed as discussed above with respect to operation 5 of FIG. 6, operation 5 of FIG. 7, or operation 3 of FIG. 8.

At block 2205, processor 1203 may transmit (through network interface 1207) an operation response associated with the consumer node responsive to receiving the operation request and based on the context information. Operation of block 2205 may be performed as discussed above with respect to operation 7 of FIG. 6, operation 7 of FIG. 7, or operation 5 of FIG. 8.

At block 2207, processor 1203 may receive (through network interface 1207) a store context request including context information. Operation of block 2207 may be performed as discussed above with respect to operation 18 of FIG. 6, operation 14 of FIG. 7, or operation 9 of FIG. 8.

At block 2209, processor 1203 may store (through network interface 1207) the context information from the store context in a storage resource associated with the service instance set. Storing the context information may include forwarding the store context request including the context information to the storage resource associated with the service instance set responsive to receiving the store context request, and receiving a store context response from the storage resource associated with the service instance set. Operation of block 2209 may be performed as discussed above with respect to operation 19 of FIG. 6, operation 15 of FIG. 7, or operation 10 of FIG. 8.

Various operations from the flow chart of FIG. 22 may be optional with respect to some embodiments of control service nodes and related methods. Regarding methods of some embodiments, for example, operations of blocks 2201 and/or 2203 of FIG. 22 may be optional.

Example embodiments of inventive concepts are set forth below.

Explanations for abbreviations from the above disclosure are provided below.

| Abbreviation | Explanation |
|---|---|
| 3GPP | 3rd. Generation Partnership Project |
| 5GC | 5th Generation Core Network |
| AMF | Access and Mobility Management Function |
| API | Application Programming Interface |
| CN | Core Network |
| CNA | Cloud Native Architecture |
| DC | Data Center |
| DNN | Data Network Name |
| DNS | Domain Name Server |
| LB | Load Balancer |
| LCM | Life Cycle Management |
| NF | Network Function |
| NRF | Network Repository Function |
| NSSAI | Network Slice Selection Assistance Information |
| PDU | Protocol Data Unit |
| SBA | Service based Architecture |
| SIS | Service Instance Set |
| SPoA | Single Point of Access |
| SUPI | Subscriber Permanent Identifier |
| UDSF | Unstructured Data Storage Function |
| UE | User Equipment |
| URI | Uniform Resource Identifier |

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a controller node of a communication network, the method comprising:
transmitting a move context request to initiate a move of context information associated with a context identifier from a first storage resource node associated with a first service instance set for a service to a second storage resource node associated with a second service instance set for the service.

2. The method of claim 1, further comprising:
receiving a first operation request for the service, wherein the first operation request includes the context identifier, and wherein the first operation request is associated with a consumer node of the communication network;
selecting the first service instance set for the first operation request based on the first operation request including the context identifier;
forwarding the first operation request for the service to the first service instance set responsive to selecting the first service instance set for the first operation request;
receiving a second operation request for the service after transmitting the move context request, wherein the second operation request includes the context identifier, and wherein the second operation request is associated with the consumer node of the communication network;
selecting the second service instance set for the second operation request based on the second operation request including the context identifier; and
forwarding the second operation request for the service to the second service instance set responsive to selecting the second service instance set for the second operation request.

3. The method of claim 2, wherein the move context request is a get context request, and wherein transmitting the move context request comprises transmitting the get context request to the first service instance set, the method further comprising:
receiving a get context response from the first service instance set, wherein the get context response corresponds to the get context request, and wherein the get context response includes the context information associated with the context identifier; and
transmitting a store context request to the second service instance set, wherein the store context request includes the context information associated with the context identifier.

4. The method of claim 3, further comprising:
storing a mapping between the context identifier and the first service instance set before selecting the first service instance; and
storing a mapping between the context identifier and the second service instance set;
wherein selecting the first service instance set comprises selecting the first service instance set based on the first operation request including the context identifier and based on the mapping between the context identifier and the first service instance set; and
wherein selecting the second service instance set comprises selecting the second service instance set based on the second operation request including the context identifier and based on the mapping between the context identifier and the second service instance set.

5. The method of claim 4, further comprising:
receiving a store context response from the second service instance set after transmitting the store context response, wherein the store context response corresponds to the store context request;
wherein storing the mapping between the context identifier and the second service instance set comprises storing the mapping between the context identifier and the second service instance set responsive to receiving the store context response.

6. The method of claim 5, wherein forwarding the first operation request to the first service instance set comprises forwarding the first operation request to a first access node (SPoA) for the first service instance set, wherein transmitting the get context request to the first service instance set comprises transmitting the get context request to the first access node for the first service instance set, wherein receiving the get context response from the first service instance set comprises receiving the get context response from the first access node for the first service instance set, wherein transmitting the store context request to the second service instance set comprises receiving the store context request from a second access node for the second service instance set, wherein receiving the store context response comprises receiving the store context response from the second access node for the second service instance set, and wherein forwarding the second operation request to the second service instance set comprises forwarding the second operation request to the second access node for the second service instance set.

7. The method of claim 3, further comprising:
receiving an indication that service from the first service instance set will be interrupted;
wherein transmitting the get context request comprises transmitting the get context request responsive to receiving the indication that service from the first service instance set will be interrupted.

8. The method of claim 7, wherein receiving the indication comprises receiving the indication from an operation and maintenance node of the communication network.

9. The method of claim 2, wherein the move context request is a transfer context request, and wherein transmitting the transfer context request comprises transmitting the transfer context request to the first service instance set, the method further comprising:
receiving a transfer context response from the first service instance set, wherein the transfer context response corresponds to the transfer context request.

10. The method of claim 9, further comprising:
storing a mapping between the context identifier and the first service instance set before selecting the first service instance; and
storing a mapping between the context identifier and the second service instance set responsive to receiving the transfer context response;
wherein selecting the first service instance set comprises selecting the first service instance set based on the first operation request including the context identifier and based on the mapping between the context identifier and the first service instance set; and
wherein selecting the second service instance set comprises selecting the second service instance set based on the second operation request including the context identifier and based on the mapping between the context identifier and the second service instance set.

11. The method of claim 10, wherein forwarding the first operation request to the first service instance set comprises forwarding the first operation request to a first access node (SPoA) for the first service instance set, wherein transmitting the transfer context request to the first service instance set comprises transmitting the get context request to the first access node for the first service instance set, wherein receiving the transfer context response from the second service instance set comprises receiving the transfer context response from a second access node for the second service instance set, and wherein forwarding the second operation request to the second service instance set comprises forwarding the second operation request to the second access node for the second service instance set.

12. The method of claim 9, further comprising:
receiving an indication to transfer the context information associated with a context identifier;
wherein transmitting the transfer context request comprises transmitting the transfer context request responsive to receiving the indication.

13. The method of claim 12, wherein at least one of:
receiving the indication comprises receiving the indication from an operation and maintenance node of the communication network; and
the indication is an indication that service from the first service instance set will be interrupted.

14. The method of claim 2, wherein forwarding the first operation request comprises forwarding the first operation request including the context identifier, and wherein the forwarding the second operation comprises forwarding the second operation request including the context identifier.

15. The method of claim 1, wherein the context identifier is associated with at least one of a device, session, and subscription.

16. The method of claim 1, wherein the first service instance set comprises a first plurality of instances of the service, and wherein the second service instance set comprises a second plurality of instances of the service.

17. The method of claim 1, wherein the context identifier is one of a plurality of context identifiers associated with the context information.

18. The method of claim 1, wherein transmitting the move context request comprises transmitting the move context request responsive to at least one of an internal event and a trigger.

19. The method of claim 2, wherein the move context request is a get context request, and wherein transmitting the move context request comprises transmitting the get context request to the first service instance set, the method further comprising:
receiving a get context response from the first service instance set, wherein the get context response corresponds to the get context request, and wherein the get context response includes the context information associated with the context identifier.

20. The method of claim 2, wherein selecting the first service instance set comprises selecting the first service instance set based on at least one of load, a pre-configuration, and a random selection.

21. A method of operating a first service instance set for a service of a communication network, the method comprising:
receiving a move context request to initiate a move of context information from a first storage resource node associated with the first service instance set to a second storage resource node associated with a second service instance set; and
transmitting a move context communication from the first service instance set, the move context communication corresponding to the move context request, and the move context communication including the context information.

22. The method of claim 21, further comprising:
reading the context information from the first storage resource associated with the first service instance set;
wherein transmitting the move context communication comprises transmitting the move context communication including the context information based on reading the context information from the first storage resource.

23. The method of claim 22, wherein reading the context information comprises transmitting an access context request to the storage resource associated with the first service instance set responsive to receiving the move context request, and receiving an access context response from the storage resource associated with the first service instance set, wherein the access context response includes the context information.

24. The method of claim 21, wherein receiving the move context request comprises receiving a get context request from a service controller node to initiate the move of context information, and wherein transmitting the move context communication comprises transmitting a get context response including the context information to the service controller node.

25. The method of claim 24, wherein receiving the get context request from the service control node comprises receiving the get context request through an access node, and wherein transmitting the get context response comprises transmitting the get context response through the access node.

26. The method of claim 21, wherein receiving the move context request comprises receiving a transfer context request from a service control node, and wherein transmitting the move context communication comprises transmitting a store context request including the context information to the second service instance set.

27. The method of claim 26, further comprising:
receiving a store context response from the second service instance set; and
transmitting a transfer context response to the service controller node responsive to receiving the store context response, wherein the transfer context response corresponds to the transfer context request.

28. The method of claim 27, wherein receiving the transfer context request from the service controller node comprises receiving the transfer context request through an access node, and wherein transmitting the transfer context response to the service controller node comprises transmitting the transfer context response through the access node.

29. The method of claim 21, wherein receiving the move context request comprises receiving the move context request from an operation and management node of the communication network, and wherein transmitting the move context communication comprises transmitting a store context request including the context information to the second service instance set.

30. The method of claim 29, further comprising:
receiving a store context response from the second service instance set, wherein the store context response corresponds to the store context request.

31. The method of claim 21, further comprising:
receiving an operation request for the service before receiving the move context request, wherein the operation request includes a context identifier, and wherein the operation request is associated with a consumer node of the communication network;
obtaining the context information from the first storage resource node responsive to receiving the operation request including the context identifier; and
transmitting an operation response associated with the consumer node responsive to receiving the operation request and based on the context information.

32. A method of operating a first service instance set for a service of a communication network, the method comprising:
transmitting a move context communication from a first service instance set associated with a first storage resource, the move context communication including context information from the first storage resource to be moved from the first storage resource node to a second storage resource node associated with a second service instance set.

33.-49. (canceled)
